(19) United States
(12) Patent Application Publication
(10) Pub. No.: US 2023/0068599 A1
(43) Pub. Date: Mar. 2, 2023

(54) TRACK LINK SPACING SENSORS

(71) Applicant: CATERPILLAR INC., PEORIA, IL (US)

(72) Inventor: Eric James Johannsen, Washington, IL (US)

(73) Assignee: CATERPILLAR INC., PEORIA, IL (US)

(21) Appl. No.: 17/459,637

(22) Filed: Aug. 27, 2021

(51) Int. Cl. G08C 23/00

(52) U.S. Cl. CPC G08C 23/00

(57) ABSTRACT

A wear monitoring system includes a pair of track links for a track assembly of a machine, with a sensing device disposed within a cavity formed in a link body of each of the pair of track links. One or more communication devices are associated with the sensing devices, and a computing device is wirelessly connected over a communication network with each of the communication devices. One or more of the sensing devices and the computing device are configured to detect one or more of a distance between the sensing device disposed in one of the pair of track links and the sensing device disposed in another of the pair of track links, and a distance between the sensing device disposed in one of the pair of track links and a remote device. The computing device is configured to determine internal wear between components of at least one of the pair of track links based on changes in the detected distance.

### TECHNICAL FIELD

The present disclosure is directed to a pair of track links and, more particularly, to a pair of track links including sensing devices for determining a distance between the track links.

### BACKGROUND

A mobile machine may be used to perform various types of work on different worksites, such as a construction site, a demolition site, a mining site, or a landfill site. For example, a bulldozer may be used to push soil and rock on a construction site. The bulldozer, as a track-type mobile machine, includes a tracked undercarriage with tracks on the left and right sides of the machine. Each of the tracks includes a chain formed by connecting a number of track links to one another, and connecting a number of track shoes to the chains. The tracks are supported by various roller assemblies on both sides of the machine.

Operation of the mobile machine inevitably results in wear or damage to various components, including components of the undercarriage such as the track links and the roller assemblies. For example, as a track assembly operates, a surface of each track link may wear away through contact with other components of the track assembly, machine, and/or outside materials (e.g., the ground). In a machine with a low percentage of traveling time—such as a hydraulic mining shovel or an electric rope shovel, internal wear such as wear between track pins and bushings that pivotally interconnect track links in a chain may be a more significant source of wear. In some applications with low percentage of traveling times, the pins and bushings may be provided with less lubrication than in machines with a high percentage of traveling times—such as bulldozers and track-type tractors, thus resulting in more internal wear on the pins and/or bushings interconnecting the track links in a chain used on the machines with low percentage of traveling times. Different types of machines may experience different types of wear to track links or other undercarriage components. It is known to service or replace a machine component, for example, when the component exceeds its expected lifetime (based on the age of the component or number of hours of use experienced by the component), or based on the results of inspection or evaluation of the component.

These known methods for determining when components are to be serviced or replaced suffer from numerous disadvantages. For example, a particular machine component may be capable of being used far in excess of its expected lifetime, and thus replacement of the component based solely on age may be premature and result in unnecessary costs and machine down-time. Conversely, a particular machine component may fail well in advance of its expected lifetime, and continued operation of the machine with the damaged component may result in damage to other components of the machine. Similarly, inspection and evaluation of a machine component may result in unnecessary costs and machine down-time when it is determined that service or replacement of the component is not required. Still further, inspection and evaluation may require that the machine be evaluated by temporarily installing various sensors throughout the machine, with extensive cabling connecting the sensor to a computer that collects data and other information from the sensors. The cabling prevents the machine from being operated on the worksite, and thus such evaluation does not provide information relating to the actual use of the machine while performing work.

Thus, there exists a need for an improved monitoring system for collecting information, such as wear information, related to a mobile machine. In addition, there exists a need for wear monitoring systems adapted to the particular type of use a machine will experience, and characteristics of the type of machine, such as whether wear is more likely to occur on external surfaces of the tracked links of a tracked undercarriage, or on internal components, such as the pins and bushings interconnecting the track links of a chain of track links. The present disclosure is directed to overcoming one or more of the problems set forth above and/or other problems of the prior art.

### SUMMARY

In one aspect, a wear monitoring system may include a pair of track links and connected track shoes for a track assembly of a machine, a sensing device disposed at least partially within a cavity formed in one or more of a link body of each of the pair of track links or the track shoe connected to the link body, one or more communication devices associated with the sensing devices, and a computing device wirelessly connected over a communication network with each of the communication devices. One or more of the sensing devices and the computing device may be configured to detect one or more of a distance between the sensing device disposed at least partially within one of the pair of track links or track shoes and the sensing device disposed at least partially within another of the pair of track links or track shoes, and a distance between the sensing device disposed at least partially within one of the pair of track links or track shoes and a remote device. The computing device may be configured to determine internal wear between components of each of the pair of track links based on changes in the detected distance.

In another aspect, a method of monitoring internal wear of track links included in a track chain for a machine includes disposing a sensing device at least partially within a cavity formed in one or more of a link body of each of a pair of track links or a track shoe connected to the link body in the track chain of the machine. One or more communication devices are communicatively associated with the sensing devices, and a computing device is wirelessly connected over a communication network with each of the communication devices. One or more of the sensing devices and the computing device detect one or more of a distance between the sensing device disposed at least partially within one of the pair of track links or track shoes and the sensing device disposed at least partially within another of the pair of track links or track shoes, and a distance between the sensing device disposed at least partially within one of the pair of track links or track shoes and a remote device. The computing device determines internal wear between components of each of the pair of track links based on changes in one of the detected distance between the sensing devices disposed at least partially within each of the pair of track links or track shoes or the detected distance between a sensing device disposed at least partially within one of the pair of track links or track shoes and the remote device.

In yet another aspect, a track assembly of a machine is disclosed, wherein the track assembly includes a wear monitoring system. The wear monitoring system for the track assembly may include a pair of track links and connected track shoes of the track assembly, a sensing device disposed at least partially within a cavity formed in one or more of a link body of each of the pair of track links or a track shoe connected to the link body, one or more communication devices associated with the sensing devices, and a computing device wirelessly connected over a communication network with each of the communication devices. One or more of the sensing devices and the computing device may be configured to detect one or more of a distance between the sensing device disposed at least partially within one of the pair of track links or track shoes and the sensing device disposed at least partially within another of the pair of track links or track shoes, and a distance between the sensing device disposed at least partially within one of the pair of track links and a remote device. The computing device may be configured to determine internal wear between components of each of the pair of track links based on changes in one of the detected distance between the sensing devices disposed at least partially within each of the pair of track links or connected track shoes or the detected distance between a sensing device disposed at least partially within one of the pair of track links or track shoes and the remote device.

### BRIEF DESCRIPTION OF THE DRAWINGS

FIG. 1 illustrates an exemplary track-type machine, consistent with disclosed embodiments;

FIG. 2 illustrates an exemplary portion of a track assembly of the track-type machine of FIG. 1;

FIG. 3 illustrates an exemplary wear detection system that may be used in conjunction with the track-type machine of FIG. 1;

FIG. 4 illustrates an exemplary sensing device that may be used in conjunction with the wear detection system of FIG. 3; and

FIG. 5 illustrates a portion of an exemplary track link including the sensing device of FIG. 4.

### DETAILED DESCRIPTION

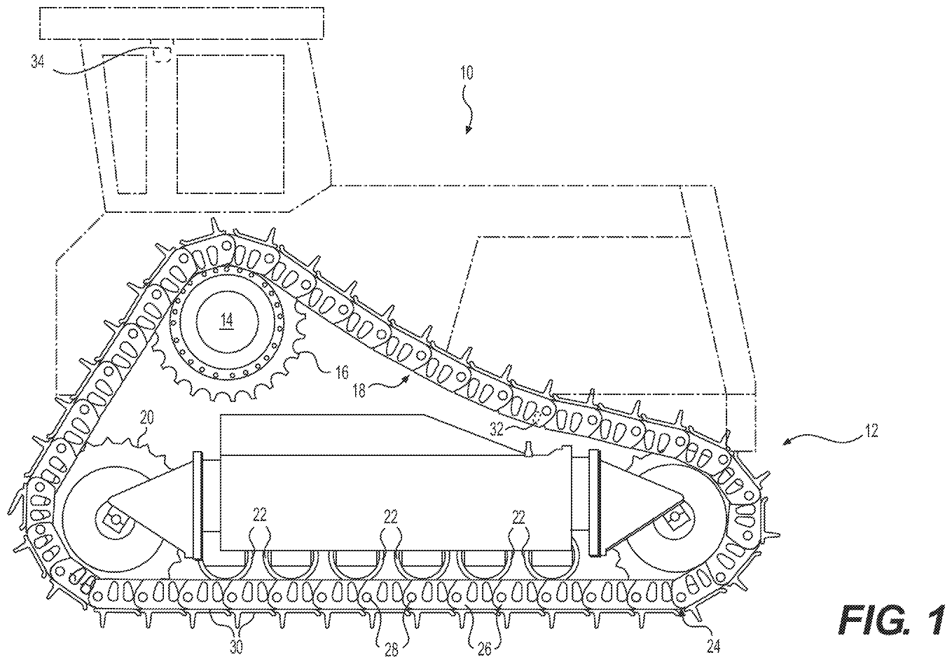

FIG. 1 illustrates an exemplary track-type machine 10, consistent with disclosed embodiments. Track-type machine 10 may embody any machine that is driven, propelled, positioned, and/or maneuvered by operating a “continuous” track-type traction device. Such machines may include, for example, track-type tractors, skid steers, dozers, excavators, backhoes, track loaders, front shovels, electric rope shovels, hydraulic mining shovels, or any other type of track-maneuverable machine. Machine 10 may include a pair of track assemblies 12 (only one shown) on opposing sides of machine 10 and driven by a driving mechanism 14. Track assembly 12 may include a drive sprocket 16 coupled to driving mechanism 14, and a chain assembly 18 operatively coupled to driving mechanism 14 by drive sprocket 16 and configured to propel machine 10 when driven by driving mechanism 14.

Driving mechanism 14 may include one or more components configured to generate a torque output. For example, driving mechanism 14 may include any suitable type of internal combustion engine, such as a gasoline, diesel, natural gas, or hybrid-powered engine or turbine. Alternatively or additionally, driving mechanism 14 may embody an electric motor, electrically coupled to an electric power source and configured to convert at least a portion of the electrical energy from the electric power output into mechanical energy. According to yet another embodiment, driving mechanism 14 may include a hydraulic motor fluidly coupled to a hydraulic pump and configured to convert a fluid pressurized by the pump into a torque output.

Drive sprocket 16 may be coupled to driving mechanism 14 via a shaft (not shown), which may provide an interface for delivering torque generated by driving mechanism 14 to drive sprocket 16. For example, drive sprocket 16 may be secured (e.g., welded, bolted, heat-coupled, etc.) to a hub associated with a shaft (not shown), so that drive sprocket 16 rotates in response to the torque generated by driving mechanism 14. In some embodiments, drive sprocket 16 may be directly coupled via a drive shaft to driving mechanism 14. Alternatively, drive sprocket 16 may be coupled to driving mechanism 14 via a torque converter (such as a gearbox, transmission, etc.), so that rotation of drive sprocket 16 is proportional to the torque generated by driving mechanism 14.

Track assembly 12 may include a plurality of components that form the “continuous” track, ground-engaging portion of the drive system of machine 10. Track assembly 12 may include, among other things, drive sprocket 16, chain assembly 18, at least one idler 20, a plurality of rollers 22, and a traction assembly 24. However, it should be understood that these components of track assembly 12 are exemplary only and not intended to be limiting. Accordingly, track assembly 12 may include additional and/or different components than those listed above.

Chain assembly 18 may form a continuous chain connected around outer portions of drive sprocket 16, idlers 20, and rollers 22. Traction assembly 24 may be connected to an outer portion of chain assembly 18 and configured to engage a ground surface beneath track-type machine 10. In use, rotation of drive sprocket 16 may cause chain assembly 18 to move around drive sprocket 16, idlers 20, rollers 22 and traction assembly 24 to engage the ground and thereby propel track-type machine 10 in a manner known in the art.

In an exemplary embodiment, chain assembly 18 may include a plurality of interconnected track links 26. It should be understood that “track link,” as used herein, refers to any linkage component of a continuous chain for a track-type machine, and is not limited to track links 26 described herein. For example, in some large machines, a “track link” may be a one piece pad. In one embodiment, adjacent (e.g., consecutive) track links 26 may be coupled together via a plurality of track pin assemblies 28. Each track pin assembly 28 may be engaged by teeth of drive sprocket 16 to drive chain assembly 18 around drive sprocket 16, idlers 20, and rollers 22.

Traction assembly 24 may include a plurality of track shoes 30 secured to chain assembly 18. Each track shoe 30 may include a connecting portion configured to be secured to one or more track links 26 and a ground engaging portion configured to contact the ground. The ground engaging portion may include one or more features (e.g., grouser bars) that provide increased traction between track shoes 30 and the ground. It should be understood, however, that the disclosed embodiments may be used with any type of track shoe forming a part of a track assembly used by a track-type mobile machine. In some embodiments, track shoes 30 may be integrally formed with track links 26. In other embodiments, track shoes 30 may be omitted entirely from track assembly 12, so that surfaces of track links 26 that would otherwise contact track shoes 30 may contact the ground surface under machine 10.

In an exemplary embodiment, track-type machine 10 may include one or more components of a detection system configured to monitor a parameter of track assembly 12. For example, track-type machine 10 may include at least one sensing device 32 and at least one communication device 34. Sensing device 32 may be an electronic device configured to detect a parameter of track assembly 12 and transmit a signal indicative of the parameter to communication device 34. Communication device 34 may be configured to forward information received from sensing device 32 to another device, such as an on-board or off-board computer. In this way, information associated with a parameter of track assembly 12 may be automatically determined and routed to an appropriate destination (e.g., for display to an operator).

In an exemplary embodiment, the detection system may be configured to monitor a wear parameter. Detection of a wear parameter associated with track assembly 12 may include detecting a change in distance between a sensing device 32 located on one of an adjacent pair of track links 26 or connected track shoes and a sensing device 32 located on the other of the adjacent pair of track links 26. Alternatively, or in addition, detection of a wear parameter associated with track assembly 12 may include detecting a change in distance between a sensing device 32 located on one of the pair of track links 26 or connected track shoes and a remote device. The distance between a sensing device 32 located on one of the pair of track links 26 or connected track shoes and the remote device may be subtracted from a distance between a sensing device 32 located on the other of the pair of track links 26 or connected track shoes and the remote device in order to determine the distance between the sensing devices located on each of the pair of track links 26. A change in the determined distance between the sensing devices on each of the pair of track links or connected track shoes may be indicative of internal wear of components of drive chain assembly 18. For example, internal wear of components such as a track pin and bushing used for interconnecting the pair of track links may result in increased clearance between the track pin and the bushing within which the track pin is received. Such an increase in clearance between the track pin and the surrounding bushing may result in an increase in the length between the sensing devices on each of the adjacent pair of track links or connected track shoes.

In an exemplary embodiment, sensing device 32 may be mounted in, on, or around a track link 26 and configured to provide a signal indicative of the location of sensing device 32. In alternative embodiments, sensing device 32 may be located at least partially within or on other components of a track chain such as a connected track shoe. For example, sensing device 32 may be a transponder associated with a GPS device and configured to provide a signal that can be processed by the GPS device to provide a geographical position of the sensing device 32 relative to a coordinate system. Alternative sensing devices may include laser devices, radar devices, infrared devices, RFID devices, and magnetic devices. In an exemplary embodiment, a sensing device 32 may be secured to track link 26. In one embodiment, sensing device 32 may be at least partially embedded in the body of track link 26 or connected track shoe. In another embodiment, sensing device 32 may be externally mounted to the body of track link 26 or connected track shoe.

Communication device 34 may be positioned anywhere on machine 10 that allows communication device 34 to receive signals from sensing device 32. As shown in FIG. 1, communication device 34 may be installed in an interior of an operator cabin of machine 10, such as on a ceiling or floor thereof. In other embodiments, communication device 34 may be mounted to an exterior portion of machine 10, such as on top of the operator cabin or on a machine chassis.

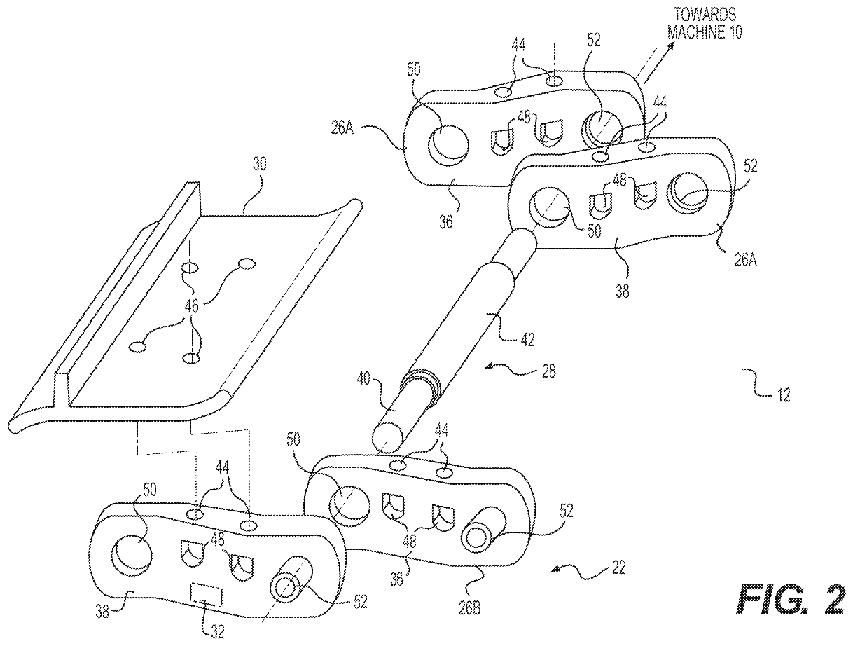

FIG. 2 illustrates a portion of track assembly 12 in more detail, including four track links 26, one track pin assembly 28, and one track shoe 30. As shown in FIG. 2, track links 26 may include track links 26A and track links 26B. Track links 26A and 26B may be mirror images of each other, and may be disposed opposite one another within track assembly 12, such that track links 26A form one side of track assembly 12 (e.g., side of track assembly nearest to a center of machine 10), while track links 26B form the opposite side of track assembly 12 (e.g., a side of track assembly farthest from the center of machine 10).

When the components shown in FIG. 2 are assembled with one another, one track pin assembly 28 may be used to connect four track links 26 (e.g., two track links 26A and two track links 26B), one track shoe 30 may be connected to one track link 26A and one track link 26B, and another track shoe 30 (not shown) may be connected to the other track link 26A and the other track link 26B.

Each track link 26 may include an inward-facing surface 36 and an outward-facing surface 38. Inward-facing surfaces 36 may face toward a center of chain assembly 18 (e.g., toward the opposite-side chain). Outward-facing surfaces 38 may face away from the center of chain assembly 18 (e.g., toward the center of machine 10 on the side of chain assembly 18 closest to machine 10 and away from the center of machine 10 on the side of chain assembly 18 furthest from machine 10). As shown in FIG. 2, track links 26A, 26B may be connected to each other such that an inward-facing surface 36 is connected to an outward-facing surface 38 of an adjacent track link 26. It should be understood, however, that other track link configurations are possible.

As shown in FIG. 2, each track pin assembly 28 that connects track links 26 may include a track pin 40 and a bushing 42. Bushing 42 may be disposed on track pin 40, such that bushing 42 rotates relative to track pin 40. By this arrangement, drive sprocket 16 (FIG. 1) may engage bushing 42, and bushing 42 may rotate on track pin 40 with drive sprocket 16. As a result of the force applied to bushing 42, track pin 40 may translate, resulting in movement of track assembly 12 to move machine 10 on the ground surface in a manner known in the art.

Each track link 26A and 26B may include one or more through holes 44, while each track shoe 30 may include corresponding through holes 46. Each track link 26A and 26B may also include one or more openings 48 aligned with through hole 44. By this arrangement, threaded fasteners such as bolts (not shown) may be disposed within through holes 44 and 46 to attach track shoes 30 to track links 26A and 26B, and corresponding threaded fasteners such as nuts (not shown) may be disposed on the ends of the bolts. Openings 48 may be formed to facilitate placement or tightening of the nuts on the ends of the bolts, such as by being sized, shaped, or located to accommodate a tool that may be used to tighten the nuts.

Each of track links 26A and 26B may define a plurality of additional through holes 50, 52 configured to receive at least a portion of track pin assemblies 28 in a manner known in the art. For example, through holes 50 may be configured to receive a portion of bushing 42 and through holes 52 may be configured to receive a portion of a free end of track pin 40. In this way, pivot joints may be formed at track pin assemblies 28, allowing chain assembly 18 to move freely around drive sprocket 16, idlers 20, and rollers 22 during operation.

As shown in FIG. 2, one or more of track links 26A, 26B may include sensing device 32. Although not shown in FIG. 2, an alternative embodiment may include sensing device 32 disposed at least partially within the track shoe connected to one or more of the track links. The track link 26A, 26B selected to include sensing device 32 may depend on a number of factors, such as track link position within track assembly 12 and orientation with respect to machine 10, and the means by which sensing device 32 is mounted to the selected track link 26. For example, if either of track links 26A includes sensing device 32, sensing device 32 would be positioned closer to machine 10 than if either of track links 26B includes sensing device 32. Similarly, if sensing device 32 is mounted to or adjacent an inward-facing surface 36 or outward-facing surface 38, the orientation of the selected track link 26 will determine whether sensing device 32 faces toward machine 10 or away from machine 10. In an exemplary embodiment, these factors may be considered when determining the position of a track link 26 that includes sensing device 32.

In one embodiment, a track link 26A, 26B may be selected for including sensing device 32 such that sensing device 32 is capable of reliably communicating with communication device 34. Thus, the track link 26A, 26B that is selected may also depend on a position of communication device 34 on machine 10. As shown in FIG. 2, in an exemplary embodiment sensing device 32 may be mounted to an outward-facing surface 38 of a track link 26B, such that sensing device 32 is positioned farthest from machine 10, and faces away from machine 10. This positioning may allow for reliable communication with communication device 34, since signals may at least partially avoid traveling through components of machine 10 to reach communication device 34. In other embodiments, however, other positions and orientations of sensing device 32 may provide the same or better reliability of communication.

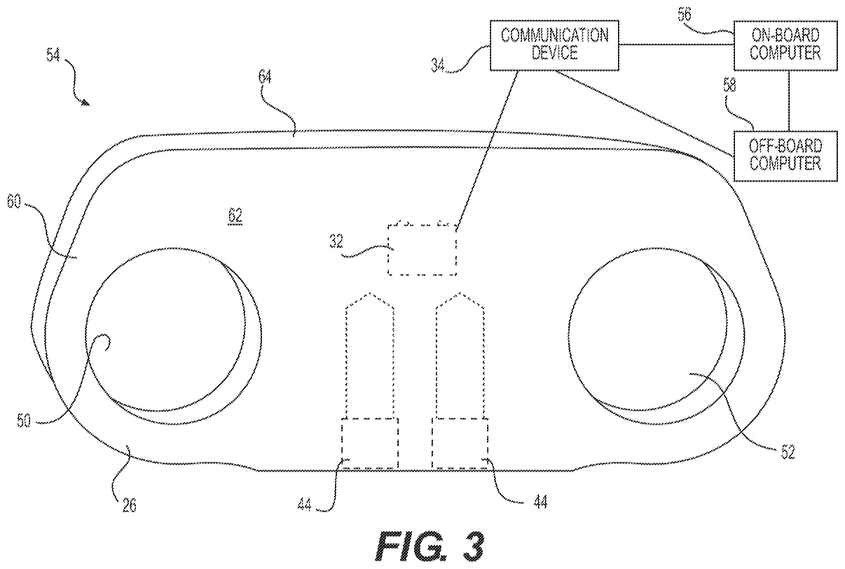

FIG. 3 illustrates an exemplary detection system 54 that includes sensing device 32 and communication device 34. In an exemplary embodiment, detection system 54 may also include an on-board computer 56 and an off-board computer or remote device 58. Sensing device 32 may be mounted to a track link 26 and configured to transmit a signal indicative of a location of sensing device 32 to communication device 34. Communication device 34 may be configured to receive the signal and transmit a corresponding signal to on-board computer 56 and/or off-board computer or remote device 58.

As shown in FIG. 3, sensing device 32 may be positioned on or in a link body 60 of a track link 26, proximate to a surface 62 and a surface 64. In one exemplary embodiment, sensing device 32 may be positioned at least partially within a cavity formed in surface 62 such that sensing device 32 is at least partially embedded within link body 60. Sensing device 32 may be secured in a manner that allows signals produced by sensing device 32 to be transmitted outside of link body 60, such as through the cavity, perpendicular to surface 62 or surface 64.

In an exemplary embodiment, sensing device 32 may be positioned partially or completely within a cavity formed in outward-facing surface 38 of a track link 26B. Alternative embodiments may embed sensing device 32 in other surfaces of the track link or at least partially within a cavity formed in a connected track shoe. In the case of GPS-type, radio-frequency-type, radar-type, laser-type, infrared-type and other types of sensing devices that require line-of-sight access for receiving and/or transmitting signals indicative of the location of the sensing device, sensing device 32 may be positioned only partially within a cavity, or may be attached to an exterior surface of the track link. In the case of a magnetic-type sensing device such as a magnetic tag that may be embedded in a metal part such as a track link or connected track shoe, and still provide a wireless signal indicative of the location of the tag, sensing device 32 may be completely contained within a cavity in the track link or connected track shoe and potted in place with an epoxy material or other protective material.

According to various exemplary embodiments of this disclosure, a sensing device 32 may be provided on each of two immediately adjacent track links or connected track shoes, or a pair of sensing devices 32 may each be located on track links or connected track shoes that are separated from each other by one or more intermediate track links in a track chain. As discussed above, a change in the distance between the sensing devices located on each track link 26 may be indicative of internal wear in one or more track pin assemblies 28 interconnecting track links 26. Such internal wear of the components in a track pin assembly 28 may include wear on an exterior surface of pin 40 where pin 40 engages through hole 50, wear on an internal surface of through hole 50, wear on an exterior surface of pin 40 where pin 40 engages an internal bore through bushing 42, wear on an internal surface of the bore through bushing 42, wear on an exterior surface of bushing 42, or wear at other locations on the components of track pin assembly 28 or other components in a track chain. As one or more of the components wear with use, track links 26 may move apart under load, resulting in a sloppy fit between each track pin assembly 28 and drive sprocket 16. Placement of a sensing device 32 on each of two immediately adjacent track links for all of the track links in a track chain may enable accurate identification of exactly where internal wear is occurring along the track chain. In some applications, it may be desirable to place a sensing device 32 on at least one track link connected with each track pin assembly 28 so that any change in distance between track pin assemblies may be determined, and corrective actions may be taken. In situations where it is not necessary to pinpoint the location of internal wear within the individual track links of a track chain, the sensing devices may be positioned on track links that are spaced apart from each other by one or more intermediate track links. The placement of sensing devices 32 on track links separated by one or more intermediate track links may enable diagnosis of a section of a track chain that may need repair or replacement as a result of excessive internal wear of components located within that section.

Each sensing device 32 may include one or more components (e.g., antenna, transceiver, transmitter, etc.) that are configured to transmit a signal indicative of a location of that sensing device to communication device 34. Communication device 34 may be configured to receive the signal from one or more sensing devices 32 and transmit a corresponding signal to on-board computer 56 and/or off-board computer or remote device 58. In one embodiment, communication device 34 may include an antenna configured to receive a signal from one sensing device and forward the signal to another device. In some embodiments, communication device 34 may also include a processor and memory for processing and/or storage of information (e.g., distances between adjacent sensing devices 32).

On-board computer 56 may be a computing device located on machine 10 (e.g., inside the operator cabin). For example, on-board computer 56 may be a dashboard computer including at least a processor and a display. On-board computer 56 may communicate with communication device 34 (e.g., via a wired or wireless connection) to receive location information for one or more sensing devices 32 on one or more track links 26. On-board computer 56 may display information on whether the distance between sensing devices on different track links 26 exceeds a predetermined threshold (e.g., to an operator of machine 10), indicative of excessive wear on one or more internal components of one or more track link assemblies.

Off-board computer or remote device 58 may be a similar computing device located away from machine 10 (e.g., inside a control building). Off-board computer or remote device 58 may also include at least a processor and a display, and may be configured to communicate with communication device 34 and/or on-board computer 56 (e.g., via a wireless network) to similarly receive information on the distance between sensing devices located on track links, which may be displayed to an operator (e.g., a machine supervisor) away from machine 10.

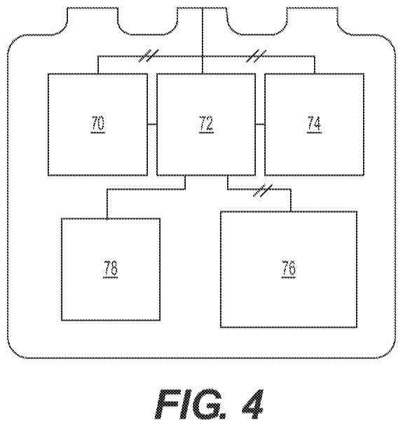

FIG. 4 illustrates an exemplary embodiment of sensing device 32. Sensing device 32 may include one or more tangible, non-transitory hardware components, including one or more central processing units (CPUs) or processors. For example, sensing device 32 may include circuitry components 70 configured to generate, receive, transmit, and/or modify a signal indicative of a location of sensing device 32. For example, circuitry components 70 may include a signal conditioner, an amplifier, a multiplexer, and/or a converter (e.g., an analog-to-digital (A/D) converter or a digital-to-analog (D/A) converter). It should be understood that these components are exemplary and that additional and/or alternative circuitry components may be used, depending on the configuration of sensing device 32.

A controller 72, such as a low-power microcontroller, may provide an output in response to the input received from circuitry components 70 and/or one or more signals processed by any or all of circuitry components 70. A memory device 74, such as either or both of a random-access memory (RAM) and a read-only memory (ROM), may store information related to one or more of the inputs or processed signals from circuitry components 70, and the output from controller 72. Alternatively or additionally, memory device 74 may store instructions used by one or more other components of sensing device 32 (or other components of detection system 54), such as controller 72.

A transceiver 76, such as for example a radio-frequency (RF) transceiver, may wirelessly broadcast the output provided by controller 72 (e.g., to communication device 34). Alternatively or additionally, an output port (not shown), such as for example a USB (universal serial bus) port or similar port, may transmit the output provided by controller 72 through a cable or other connection removably connected to the output port.

A power source 78 may power one or more of the components of sensing device 32. In one embodiment, power source 78 may include a battery, such as a coin-cell type battery. In some embodiments, power source 78 may additionally or alternatively include a motion-based energy source, such as a vibration-based energy-harvesting system, to power one or more of the components of sensing device 32, and/or may be used to charge a battery of power source 78. In yet another embodiment, power source 78 may include a battery capable of being wirelessly charged (e.g., near-field charging). In this way, sensing device 32 may be embedded within link body 60 while being capable of receiving electrical power from outside of link body 60, and thus reducing on-board power (e.g., battery) requirements.

Although FIG. 4 shows examples of specific components used by sensing device 32, sensing device 32 is not limited to the particular configuration shown. Rather, consistent with the disclosure, sensing device 32 may include other components, more components, or fewer components than those described above. Further, it is contemplated that one or more of the hardware components listed above may be implemented in part or wholly using software. One or more of such software components may be stored on a tangible, non-transitory computer-readable storage medium that includes computer-executable instructions that, when executed by a processor or other computer hardware, perform methods and processes consistent with the disclosure.

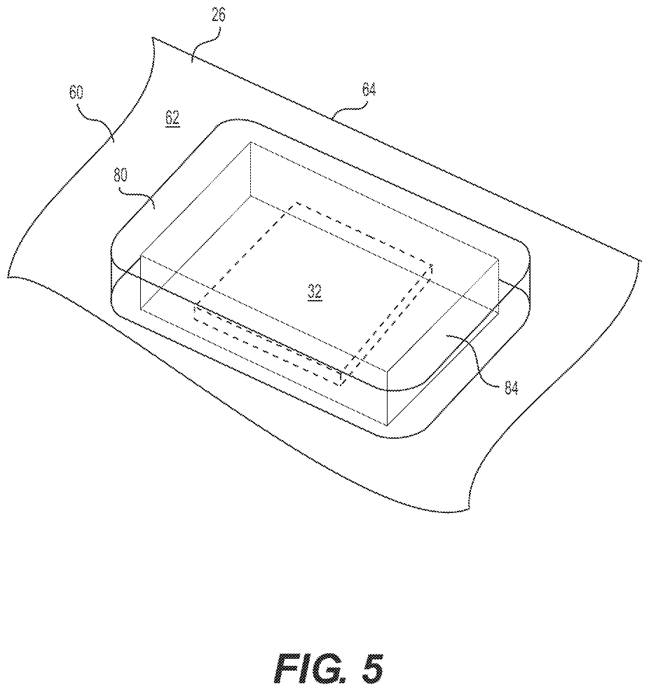

FIG. 5 illustrates an exemplary track link 26 in which a sensing device 32 has been installed. In an exemplary embodiment, track link 26 may include a cavity 80 formed in one of surfaces 36, 38, 62, 64. Cavity 80 may be sized and shaped to receive at least a portion of sensing device 32. Sensing device 32 may be positioned in cavity 80 and held in place by a containment mechanism 84. Containment mechanism 84 may be a material, device, or system configured to hold sensing device 32 in place in cavity 80. In one embodiment, containment mechanism 84 may be an encasing material filling cavity 80, with sensing device 32 embedded therein. In another embodiment, containment mechanism 84 may be a housing configured to house sensing device 32 and be received in cavity 80. In some embodiments, containment mechanism 84 may include a cover (not shown) configured to seal an opening into cavity 80 at surface 36, 38, 62, 64. For example, sensing device 32 may be held in place by fasteners (e.g., threaded fasteners) and a cover may close sensing device 32 within cavity 80 to protect sensing device 32 from damage.

While cavity 80 and containment mechanism 84 are depicted and described, it should be understood that there may be other means for mounting sensing device 32 to track link 26. An exemplary process for monitoring internal wear of track links included in a track chain for a machine is described in more detail below.

### INDUSTRIAL APPLICABILITY

The exemplary disclosed wear monitoring system pair of track links having a wear sensing device may be applicable to a track assembly of any track-type machine. The track link and wear sensing device may be used to monitor a wear parameter associated with the track link and automatically transmit a signal indicative of the wear parameter to a computing device for further use. Since wear of a track link may be indicative of the remaining life of a machine undercarriage (e.g., a chain assembly of the undercarriage), the disclosed embodiments may allow for a determination of a state of a machine undercarriage (e.g., whether critical wear levels have been reached, structural health of the undercarriage, etc.). Further, monitoring of a wear parameter may allow an operator to accurately make inventory part predictions, proactively schedule machine maintenance, and easily and efficiently track wear rates.

In addition, the exemplary disclosed detection system, including an embedded sensing device and strategically positioned communication device, may allow for reliable monitoring of a wear parameter of a track link. Positioning the sensing device at least partially within the track link or connected track shoe, or firmly mounted to the track link or track shoe, protects the sensing device from damage during use of the associated track assembly. In the case of non-line-of-sight sensing devices such as a magnetic sensor, it is possible to embed the sensing device in the metal body of the track link or connected track shoe while still allowing for communication of signals indicative of the exact position of the sensing device on each of the pair of track links.

In an exemplary embodiment, an existing (e.g., manufactured) track link 26 may be selected and cavity 80 may be machined therein. In other embodiments, track link 26 may be manufactured (e.g., cast, forged, 3-D printed, etc.) with cavity 80 formed therein. In one embodiment, cavity 80 may be formed as a recess in outward-facing surface 38 of link body 60. In other embodiments, cavity 80 may be located elsewhere on link body 60. In some embodiments, a passage may be machined and/or formed adjacent to cavity 80 and extending to a wear surface of track link 26, to receive a wear portion of sensing device 32, with the wear portion actually being worn away as the wear surface is worn away.

With cavity 80 formed in link body 60, sensing device 32 may be placed in cavity 80 and secured therein by containment mechanism 84. In one embodiment, containment mechanism 84 may be a material configured to fill cavity 80 with sensing device 32 embedded therein. For example, containment mechanism 84 may be a potting epoxy that may be poured/injected into cavity 80 with sensing device 32 positioned therein. The potting epoxy may cure to form a solid material, thereby holding sensing device 32 in place. The material used to embed sensing device 32 may have sufficient strength to prevent damage to sensing device 32 while also being capable of allowing signals to be transmitted therethrough (such that wireless transmissions between sensing device 32 and communication device 34 may be reliably made).

In another embodiment, containment mechanism 84 may be a housing configured to be received in cavity 80. The housing may removably or permanently receive and protect sensing device 32 therein and may be removably or permanently insertable into cavity 80. In one example, the housing may removably receive sensing device 32 therein. In addition, the housing may be removably received in cavity 80 (e.g., the housing may include threads, a detent mechanism, clips, etc., that mate with a corresponding feature of cavity 80). In this way, sensing device 32 (and/or a housing including sensing device 32) may be accessible (e.g., for replacement, service, wired connection, etc.).

As described herein, containment mechanism 84 may be configured to allow signals produced by sensing device 32 to pass therethrough. For example, the material of containment mechanism 84 may be substantially transparent to radio transmissions produced by transceiver 76. Further, when installed on machine 10, track link 26 that includes sensing device 32 may be positioned such that cavity 80 faces away from a center of machine 10. In this way, an exposed portion of containment mechanism 84 may face away from machine 10, thus allowing signals transmitted by sensing device 32 to be more easily broadcast away from track assembly 12 (e.g., and to communication device 34) by avoiding travel solid components of machine 10.

Sensing device 32 mounted to track link 26 may be configured to generate a signal indicative of the location of the device such that a distance between the device and another similar device on another track link of the same chain can be determined with accuracy. Example of such devices may include a GPS sensor, a magnetic sensing device, a laser device, a radio frequency device, etc. A change in the distance between the sensing devices located on each track link 26 may be indicative of internal wear in one or more track pin assemblies 28 interconnecting track links 26. Such internal wear of the components in a track pin assembly 28 may include wear on an exterior surface of pin 40 where pin 40 engages through hole 50, wear on an internal surface of through hole 50, wear on an exterior surface of pin 40 where pin 40 engages an internal bore through bushing 42, wear on an internal surface of the bore through bushing 42, wear on an exterior surface of bushing 42, or wear at other locations on the components of track pin assembly 28 or other components in a track chain. As one or more of the components wear with use, track links 26 may move apart under load, resulting in a sloppy fit between each track pin assembly 28 and drive sprocket 16. Placement of a sensing device 32 on each of two immediately adjacent track links for all of the track links in a track chain may enable accurate identification of exactly where internal wear is occurring along the track chain. In some applications, it may be desirable to place a sensing device 32 on at least one track link connected with each track pin assembly 28 so that any change in distance between track pin assemblies may be determined, and corrective actions may be taken. In situations where it is not necessary to pinpoint the location of internal wear within the individual track links of a track chain, the sensing devices may be positioned on track links that are spaced apart from each other by one or more intermediate track links. The placement of sensing devices 32 on track links separated by one or more intermediate track links may enable diagnosis of a section of a track chain that may need repair or replacement as a result of excessive internal wear of components located within that section.

Controller 72 may determine that a distance between sensing devices 32 on a pair of track links exceeds a threshold amount, indicative of an unacceptable amount of wear on internal components of one or both of track links 26 in the pair of track links. Transceiver 76 may transmit the signal to communication device 34. Communication device 34 may receive the signal and forward the information regarding a distance between the two sensing devices to on-board computer 56 and/or off-board computer 58. On-board computer 56 and/or off-board computer 58 may receive the signal and perform one or more processes to inform an operator of the wear, automatically schedule maintenance, update tracked wear information, estimate a remaining life of track link 26 and/or an associated track assembly 12, etc.

Through the exemplary disclosed processes, the disclosed track link 26 and sensing device 32 may provide automatic and/or on-demand monitoring of a wear parameter associated with track link 26. In addition, the use of sensing device 32 in conjunction with on-board computer 56 and/or off-board computer 58 allows wear information to be tracked and analyzed by a computing device and/or an operator (e.g., an operator within machine 10, a supervising operator in a control building, etc.). In this way, track assembly 12 may be monitored and maintained without requiring inefficient manual inspection and without relying on estimates of remaining part life. An exemplary wear monitoring system according to an embodiment of this disclosure may provide timely indications of wear of internal components of a track link in a track chain of a track assembly by accurately determining an increase in the distance between sensors on different track links of the track chain. Changes in the distance between track links can be determined using a number of different types of sensors that may be readily mounted on or in individual track links. GPS sensors, magnetic sensors, laser sensors, radar sensors, and radio frequency sensors are all examples of the types of sensing devices that may be used to provide accurate, real-time indications that a distance between two track links, such as two adjacent track links, or two track links separated by one or more intermediate track links, has changed and may be about to exceed, or may have already exceeded a predetermined threshold value. The indication that a distance between track links on a track chain has exceeded a predetermined threshold may provide a clear diagnosis of excessive wear on the internal components of one or more track links.

It will be apparent to those skilled in the art that various modifications and variations can be made to the track assembly and detection system of the present disclosure without departing from the scope of the disclosure. Other embodiments will be apparent to those skilled in the art from consideration of the specification and practice of the embodiments disclosed herein. It is intended that the specification and examples be considered as exemplary only, with a true scope of the disclosure being indicated by the following claims.

What is claimed is:

1. A wear monitoring system, comprising:
a pair of track links for a track assembly of a machine;
a sensing device disposed at least partially within a cavity formed in one or more of a link body of each of the pair of track links or a track shoe connected to the link body;
one or more communication devices associated with the sensing devices; and
a computing device wirelessly connected over a communication network with each of the communication devices, wherein
one or more of the sensing devices and the computing device are configured to detect one or more of a distance between the sensing device disposed at least partially within one of the pair of track links or track shoes and the sensing device disposed at least partially within another of the pair of track links or track shoes, and a distance between the sensing device disposed at least partially within one of the pair of track links or track shoes and a remote device, and
the computing device is configured to determine internal wear between components of at least one of the pair of track links based on changes in the detected distance.

2. The wear monitoring system of claim 1, wherein the pair of track links are immediately adjacent to each other in a track chain of the track assembly.

3. The wear monitoring system of claim 1, wherein the pair of track links are separated by one or more intermediate track links in a track chain of the track assembly.

4. The wear monitoring system of claim 1, wherein the computing device is configured to determine that internal wear between components of at least one of the pair of track links exceeds a predetermined threshold amount of wear when the distance between the sensing device disposed at least partially within one of the pair of track links or connected track shoes and the sensing device disposed at least partially within the other of the pair of track links or connected track shoes exceeds a predetermined threshold distance.

5. The wear monitoring system of claim 4, wherein the computing device is configured to determine that the distance between the sensing device disposed at least partially within one of the pair of track links or track shoes and the sensing device disposed at least partially within the other of the pair of track links or track shoes exceeds the predetermined threshold distance by comparing the distances between each of the sensing devices and the remote device.

6. The wear monitoring system of claim 1, wherein one or more of the sensing devices comprises one of a GPS sensor, a magnetic sensor, a laser sensor, a radar sensor, and a radio frequency sensor.

7. The wear monitoring system of claim 1, wherein the internal wear between components of at least one of the track links includes one or more of wear to an exterior surface of a track pin, wear to an internal bore of a through hole in the track link, wear to an internal bore of a bushing of the track link, and wear to an exterior surface of the bushing.

8. The wear monitoring system of claim 1, wherein the machine is a machine that remains stationary at least 20% of the time.

9. The wear monitoring system of claim 8, wherein the machine is one of a hydraulic mining shovel, an hydraulic excavator, or an electric rope shovel.

10. A method of monitoring internal wear of track links included in a track chain for a machine, the method comprising:
disposing a sensing device at least partially within a cavity formed in a link body of each of a pair of track links or at least partially within a cavity formed in a track shoe connected to the link body in the track chain of the machine;
communicatively associating one or more communication devices with the sensing devices;
wirelessly connecting a computing device over a communication network with each of the communication devices;
detecting one or more of a distance between the sensing device disposed at least partially within one of the pair of track links or track shoes and the sensing device disposed at least partially within another of the pair of track links or track shoes, and a distance between the sensing device disposed at least partially within one of the pair of track links or track shoes and a remote device using one or more of the sensing devices and the computing device; and
determining, using the computing device, internal wear between components of at least one of the pair of track links based on changes in one of the detected distance between the sensing devices disposed at least partially within the pair of track links or track shoes or the detected distance between a sensing device disposed at least partially within one of the pair of track links or track shoes and the remote device.

11. The method of claim 10, wherein the pair of track links are disposed immediately adjacent to each other in the track chain of the track assembly.

12. The method of claim 10, wherein the pair of track links are separated by one or more intermediate track links in the track chain of the track assembly.

13. The method of claim 10, further including determining, using the computing device, that internal wear between components of at least one of the pair of track links exceeds a predetermined threshold amount of wear when the distance between the sensing device disposed at least partially within one of the pair of track links and the sensing device disposed at least partially within the other of the pair of track links exceeds a predetermined threshold distance.

14. The method of claim 13, further including determining, using the computing device, that the distance between the sensing device disposed at least partially within one of the pair of track links and the sensing device disposed at least partially within the other of the pair of track links exceeds the predetermined threshold distance by comparing the distances between each of the sensing devices and the remote device.

15. The method of claim 10, wherein one or more of the sensing devices comprises one of a GPS sensor, a magnetic sensor, a laser sensor, a radar sensor, and a radio frequency sensor.

16. The method of claim 10, wherein the internal wear between components of at least one of the track links includes one or more of wear to an exterior surface of a track pin, wear to an internal bore of a through hole in the track link, wear to an internal bore of a bushing of the track link, and wear to an exterior surface of the bushing.

17. The method of claim 10, wherein the machine is a machine that remains stationary at least 20% of the time.

18. A track assembly of a machine, wherein the track assembly includes at least a pair of track links and a wear monitoring system, the wear monitoring system comprising:
a sensing device disposed within a cavity formed in a link body of each of the pair of track links;
one or more communication devices associated with the sensing devices; and
a computing device wirelessly connected over a communication network with each of the communication devices, wherein
one or more of the sensing devices and the computing device are configured to detect one or more of a distance between the sensing device disposed in one of the pair of track links and the sensing device disposed in another of the pair of track links, and a distance between the sensing device disposed in one of the pair of track links and a remote device, and
the computing device is configured to determine internal wear between components of at least one of the pair of track links based on changes in the detected distance.

19. The track assembly of claim 18, wherein the computing device is configured to determine that internal wear between components of at least one of the pair of track links exceeds a predetermined threshold amount of wear when the distance between the sensing device disposed in one of the pair of track links and the sensing device disposed in the other of the pair of track links exceeds a predetermined threshold distance.

20. The track assembly of claim 19, wherein the computing device is configured to determine that the distance between the sensing device disposed in one of the pair of track links and the sensing device disposed in the other of the pair of track links exceeds the predetermined threshold distance by comparing the distances between each of the sensing devices and the remote device.
